(19) United States
(12) Patent Application Publication
(10) Pub. No.: US 2010/0162578 A1
(43) Pub. Date: Jul. 1, 2010

(54) Tools having anodized aluminum blades

(76) Inventor: Gregory T. Bennett, Spartenburg, SC (US)

Correspondence Address: RICHARD L HUFF, 19304 OLNEY MILL ROAD, OLNEY, MD, 20832, US

(21) Appl. No.: 12/317,673

(22) Filed: Dec. 29, 2008

(51) Int. Cl. B26B 9/00

(52) U.S. Cl. 30/350

(57) ABSTRACT

A tool for digging or working soil in which the blade is made of anodized aluminum or anodized aluminum alloy. The anodizing process imparts additional strength, dielectric properties and a low coefficient of friction. The preferred aluminum alloy is one of the 6000 or 7000 series alloys and the preferred method of anodizing the alloy is the Type III method.

### CROSS-REFERENCE TO RELATED APPLICATIONS

(Not applicable)

### STATEMENT REGARDING FEDERALLY SPONSORED RESEARCH OR DEVELOPMENT

(Not applicable)

### REFERENCE TO SEQUENTIAL LISTING, A TABLE, OR A COMPUTER PROGRAM LISTING APPENDIX SUBMITTED ON A COMPACT DISC

(Not applicable)

### BACKGROUND OF THE INVENTION

1) Field of the Invention

This invention is in the field of tools. More particularly, this invention is in the field of tools for digging and working soil, such as tools like shovels, post hole diggers, rakes, backhoes, and hoes. Additionally, this invention is in the field of tools commonly used by electricians, such as pliers, screw drivers, and wrenches. More particularly, this invention is in the field of blades for those tools.

2) Description of the Related Art

Tools for digging and working soil are well known in the art. Also, shovels which are useful for purposes other than digging soil are known. Shovels for digging snow are known to have both aluminum blades and handles as aluminum is light and such shovels may have to be transported for miles by mountain climbers or rescue personnel. Such shovels may have to be lifted many times while removing snow from driveways or sidewalks and it is advantageous for the shovel to be light. Hoes are known to have aluminum handles to take advantage of the lightness of this metal. The blades of tools which are used for digging and working soil are conventionally made of steel as steel is hard and capable of penetrating soil without bending. Tools commonly used by electricians are conventionally made of steel for the well-know hardness of this substance. This arrangement of prior art tools appears to work satisfactorily for the most part and one of ordinary skill in the art would not actively seek to modify this arrangement.

### BRIEF SUMMARY OF THE INVENTION

The present invention seeks to provide manual or mechanical tools which are designed to penetrate soil to dig or work the soil and to provide light blades which are hard enough to penetrate the soil without bending. The blades have a low coefficient of friction so that soil can be easily removed from the blades with normal working motions and adhering clogs of dirt do not cause a problem. The blades have dielectric properties such that there is no conductivity of electrical currents through the blades and the user is not exposed to electrical shock if a blade strikes an underground electrical wire. This invention also seeks to provide tools commonly used by electricians. These tools are of sufficient hardness to adequately perform the tasks for which they are designed while having no conductivity of electrical currents, thus providing the user protection against electrical shock.

The blades for the tools of this invention are made of aluminum or an aluminum alloy for the benefit of the lightness of this metal. The preferred aluminum alloys are commonly known in the art as the 6000 and 7000 series. The most preferred alloys are those which have been strengthened by heating, such as 6061, 6063, 6101, and 7075. The blades gain the desired properties mentioned above by being anodized.

The art is aware of methods of anodizing aluminum. In anodizing, the surface of the aluminum or aluminum alloy is converted to the metal oxide. Type I anodizing uses chromic acid as an electrolyte. Type II anodizing uses a sulfuric acid electrolyte at a high temperature. Type III or hardcoating anodizing uses a sulfuric acid electrolyte at a low temperature. The preferred anodizing process for this invention is the Type III anodizing process.

### BRIEF DESCRIPTION OF THE SEVERAL VIEWS OF THE DRAWINGS

(Not applicable)

### DETAILED DESCRIPTION OF THE INVENTION

In describing this invention the part of the digging or working tool which comes into contact with the soil is referred to as the blade. For uniformity of terminology, the parts of tools usually used by electricians which come into contact with the material being worked on, such as screws, nuts, bolts, or wires, will also be referred to as the blade. This is true whether the tool is a shovel, post hole digger, hoe, backhoe, rake, pair of pliers, Phillips screw driver, straight-edge screw driver, or wrench.

To practice this invention the desired blade is prepared of aluminum or aluminum alloy. Conventional methods of preparation are used, such as stamping, forging, or pressing. Forging is preferred as this method results in the strongest blade. The preferred aluminum alloy is an alloy of the 6000 or 7000 series, preferably 6061, 6063, 6101, or 7075. In tools such as shovels, hoes, screwdrivers, and rakes having both the blade and handle made of aluminum alloy, the two parts are next welded together. In tools such as pliers and wrenches commonly used by electricians, the entire tool is preferably made of aluminum alloy. In the case of screwdrivers, the shaft and the blade are preferably made of aluminum alloy as a unit. In a preferred method, the blade (or tool) is then heat treated by known methods in order to strengthen the blade (or tool). The blade (or tool) is then anodized. The preferred anodizing method is the known hardcoating method, also known as Type III. This method uses a sulfuric acid electrolyte at a low temperature near the freezing point of water. The anodizing process imparts the properties of low coefficient of friction, dielectric properties such that electrical currents do not flow through the blades, and additional hardness and strength so that the blade will have a hardness of approximately 700 on the Rockwell C scale which is approximately equal to steel and can be used for its intended purpose without bending or breaking. In tools wherein the handle is not aluminum or an aluminum alloy, the blade is then attached to the tool handle by methods known in the art. The tool handle may be made of wood, steel, aluminum, plastic, or rubber. It is preferred that the handle is made of anodized aluminum alloy in order to take advantage of the lightness, strength, and dielectric properties of this material. When both the handle and the blade are made of anodized aluminum or aluminum alloy, welding cannot be used as a joining process after the anodizing process.

Although the invention has been described and illustrated in detail, it is to be clearly understood that the same is by way of illustration and example, and is not to be taken by way of limitation. The spirit and scope of the present invention are to be limited only by the terms of the appended claims.

1. A tool having dielectric properties, a hardness value of approximately 700 on the Rockwell C scale and having a blade made of anodized aluminum or anodized aluminum alloy.

2. The tool of claim 1 wherein, the tool is a shovel.

3. The tool of claim 1 wherein, the tool is a hoe.

4. The tool of claim 1 wherein, the tool is a rake.

5. The tool of claim 1 wherein, the tool is a backhoe.

6. The tool of claim 1 wherein, the tool is a wrench.

7. The tool of claim 1 wherein, the tool is a pair of pliers.

8. The tool of claim 1 wherein, the tool is a screwdriver.

9. The tool of claim 1 wherein, the tool is a posthole digger

10. The tool of claim 1 wherein, the blade has been heat treated.

11. The tool of claim 10 wherein, the blade is anodized aluminum alloy.

12. The tool of claim 11 wherein, the aluminum alloy is of the 6000 series or 7000 series.

13. The tool of claim 12 wherein, the aluminum alloy is designated 6061, 6063, 6101, or 7075.

14. The tool of claim 13 wherein, the anodized aluminum alloy is prepared using the Type III anodizing process.
